(19) United States
(12) Patent Application Publication
(10) Pub. No.: US 2018/0162244 A1
(43) Pub. Date: Jun. 14, 2018

(54) METHOD AND DEVICE FOR OPERATING A SEAT VENTILATION DEVICE, SEAT VENTILATION DEVICE

(71) Applicant: VOLKSWAGEN AKTIENGESELLSCHAFT, Wolfsburg (DE)

(72) Inventors: Marek GRÜNEWALD, Braunschweig (DE); Jörg HELMOLD, Liebenburg (DE)

(21) Appl. No.: 15/575,476

(22) PCT Filed: Jun. 17, 2016
(86) PCT No.: PCT/EP2016/064022

§ 371 Date: Nov. 20, 2017

(30) Foreign Application Priority Data
Jun. 17, 2015 (DE) 10 2015 211 116.4

(51) Int. Cl. B60N 2/56; B60H 1/00

(52) U.S. Cl. CPC B60N 2/5657; B60H 1/00285; B60H 1/00564; B60H 2001/006; B60H 1/00828

(57) ABSTRACT

A method for operating a seat ventilation device having at least one blower and at least one ventilation opening arranged in a seat surface and having an air-ventilation connection to the blower, wherein the blower is actuated to set a setpoint rotational speed, and wherein the setpoint rotational speed is adapted as a function of a current state value of the blower which depends on a volume flow conveyed by the blower. The adapted rotational speed is selected from a characteristic diagram as a function of the current state value, wherein the characteristic diagram is/has been produced as a function of a predefined acoustic limiting value.

### PRIORITY CLAIM

This patent application is a U.S. National Phase of International Patent Application No. PCT/EP2016/064022, filed 17 Jun. 2016, which claims priority to German Patent Application No. 10 2015 211 116.4, filed 17 Jun. 2015, the disclosures of which are incorporated herein by reference in their entireties.

### SUMMARY

Illustrative embodiments relate to a method for operating a seat ventilation device which comprises at least one blower and at least one ventilation opening which is situated in a seat surface and has an air-ventilation connection to the blower, wherein the blower is controlled to set a setpoint rotational speed, and wherein the setpoint rotational speed is adapted as a function of a present state value of the blower, which depends on a volumetric flow conveyed by the blower.

Illustrative embodiments further relate to a device for operating a seat ventilation device, which comprises at least one blower and at least one ventilation opening which is situated in a seat surface and has an air-ventilation connection to the blower, including a control unit for operating the blower. In addition, the illustrative embodiments relate to a seat ventilation device comprising such a device.

### BRIEF DESCRIPTION OF THE DRAWINGS

The disclosed embodiments are explained in greater detail in the following with reference to the drawing, in which:

FIG. 1 shows a simplified representation of a device for operating the seat ventilation device;

FIG. 2 shows a method for compiling a characteristic map, as a flow chart;

FIG. 3 shows the behavior of a seat ventilation device comprising a brushless DC motor;

FIG. 4 shows a noise development of the seat ventilation device; and

FIG. 5 shows a simplified representation of a function of the control unit.

### DETAILED DESCRIPTION

Methods, devices, and seat ventilation devices of the type mentioned at the outset are already known from the prior art. For example, the laid-open application DE 10 2012 221 415 A1 discloses a seat ventilation device comprising a blower situated in a seat, which has an air-ventilation connection to several ventilation openings formed in a seat surface, and therefore a volumetric flow to the ventilation openings and through these ventilation openings, for example, to air-condition a vehicle or a person located on the seat, is conveyed by the blower. Such seat ventilation devices are used for providing the passenger with additional comfort. The blower is electrically/electronically controlled by a device in this case, to set a desired volumetric flow, for example. As soon as a person is located on the seat, however, a counterpressure—which acts on the blower, due to the ventilation opening being partially or completely covered by the person—is increased, and therefore the actually conveyed volumetric flow changes. In the case of the ventilation device presented in the aforementioned laid-open application, this results in the rotational speed of the blower decreasing, and the operating current of the blower or of a motor of the blower increases. Conversely, when the person leaves the seat, the rotational speed increases and the operating current decreases. As the rotational speed increases, however, an emission of noise by the blower also increases. In the aforementioned document, it is therefore provided to determine—as a function of an operating current or a present rotational speed of the blower and two predefinable threshold values—whether the seat comprising the seat ventilation device is occupied or unoccupied and then, in the case of an unoccupied seat, for example, to reduce the rotational speed or switch off the motor entirely, to avoid disturbing noises.

The problem addressed by the disclosure is that of providing a method as well as a device and a seat ventilation device which ensure, in a cost-effective way, an optimal ventilation function in combination with a noise behavior, in particular, when a brushless DC motor is used as a drive motor for the blower.

The problem addressed by the disclosure is solved by a method having the features of claim 1. The disclosed method provides for the rotational speed of the seat ventilation device or of the blower to be regulated according to a characteristic map, and therefore a continuous adaptation of the rotational speed to a counterpressure acting on the blower takes place with consideration for permissible noise emissions. This is achieved by way of the adapted rotational speed being selected from a characteristic map as a function of the present state value, wherein the characteristic map is or has been compiled as a function of a predefinable acoustic limiting value. The method therefore includes a portion which is to take place temporally before the start-up of the seat ventilation device, namely the compilation of the characteristic map. To this end, the actual noise behavior of the blower is investigated under different conditions, in particular, in the presence of different counterpressures, with respect to the emissions of noise, and the result is stored in the characteristic map, and therefore the stored data can be used during the actual operation of the seat ventilation device to operate the blower in an optimal operating range with respect to the conveyed volumetric flow and the generated emissions of noise, which are distinguished by a measurable acoustic value.

According to at least one disclosed embodiment, it is provided that, to compile the characteristic map, the blower is controlled to set the predefined setpoint rotational value and the conveyed volumetric flow is varied several times by changing a counterpressure acting on the blower, wherein, in each case, an acoustic value of the blower is measured and the rotational speed is adapted in such a way that the measured acoustic value does not exceed a predefinable acoustic limiting value. To compile the characteristic map, the counterpressure acting on the blower is therefore varied, i.e., increased or decreased, and the resultant effects on the emissions of noise are determined by determining the acoustic value set by way of this variation. Different acoustic values can therefore be determined for different counterpressures or different volumetric flows. The rotational speed can then be adapted, as a function of the acoustic value with respect to the predefinable acoustic limiting value, in such a way that the registered acoustic value does not exceed the predefinable acoustic limiting value. As a result, the desired acoustic limiting value is always complied with and emissions of noise are therefore held at a permissible level, independently of the counterpressure. Since the counterpressure affects the registered state value of the blower, permissible rotational speeds which meet the condition of the acoustic limiting value can therefore be assigned to the determined state values associated with the different counterpressure variations. The characteristic map can be easily compiled in this way.

Optionally, it is also provided that, to compile the characteristic map, the rotational speed is adapted in such a way that the registered acoustic values each correspondingly to the predefined acoustic limiting value. This disclosed embodiment therefore provides that the rotational speed of the blower or of the motor of the blower is not limited to a maximum value, but rather that the rotational value is set to a value at which the maximum permitted acoustic value has been reached. As a result, it is ensured that the maximum possible volumetric flow is conveyed by the blower in any counterpressure state of the blower. As a result, an optimal relationship between the emission of noise and the conveyed volumetric flow or the ventilation output is reached.

In addition, it may be provided that the counterpressure is continuously or incrementally increased to compile the characteristic map. In the case of a continuous increase in the counterpressure, a characteristic map is provided, which has a high resolution which, during operation, provides for an accurate adaptation of the rotational speed to the prevailing counterpressure. The acoustic value of the blower is therefore continuously determined. Alternatively, if the counterpressure is incrementally increased to compile the characteristic map, the number of increments determines the resolution of the characteristic map and, therefore, the accuracy of the method during operation of the seat ventilation device. By way of the incremental increase, however, the amount of data can be reduced, and therefore the method requires fewer computations. During the read-out of the characteristic map, interpolation values for intermediate values may then be calculated. The counterpressure can also be incrementally or continuously reduced, of course, to compile the characteristic map.

According to at least one disclosed embodiment, it is provided that, to compile the characteristic map, the present state value of the blower is assigned to the presently measured acoustic value and is stored together with the acoustic value in the characteristic map. A simple and traceable assignment of state values, acoustic values, and adapted rotational speeds in the characteristic map therefore results.

In addition, it may be provided that an operating current of an electric motor, in particular, a brushless DC motor of the blower, is determined or measured as the state value. As described at the outset, the operating current changes as a function of the counterpressure acting on the blower. The prevailing counterpressure can therefore be inferred as a function of the presently registered operating current. Actually, however, a determination of the counterpressure is not necessary in the presently described method, because the rotational speed may be adapted directly as a function of the registered operating current, by using the characteristic map, in such a way that a maximum volumetric flow is achieved while also complying with the acoustic limiting value.

The disclosed device is distinguished by the fact that the control unit is specifically designed for carrying out the disclosed method. The aforementioned benefits therefore result. The control unit comprises a method or mechanism for registering the present state value, in particular, the operating current of the electric motor, and a non-volatile memory for storing the characteristic map. Further features result from that which has been described above and from the claims.

The disclosed seat ventilation device is distinguished by the disclosed device. The aforementioned benefits therefore result.

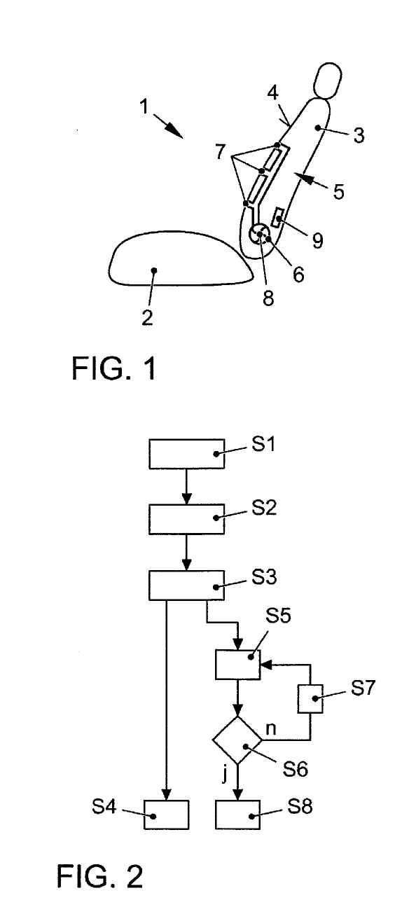

FIG. 1 shows, in a simplified representation, a vehicle seat 1 of a motor vehicle, which is not depicted here in greater detail, the vehicle seat comprising a seat part 2 and a backrest 3. The seat part 2 and the backrest 3 each have a seat surface 4, with which a passenger comes into contact when he/she sits down on the vehicle seat 1.

Integrated into the backrest 3 is a seat ventilation device 5 which comprises a blower 6 and several ventilation openings 7 which are formed/situated in the seat surface 4 of the backrest 3 and which have an air-ventilation connection to the blower 6 via air lines in the backrest 3. The blower 6 comprises an electric motor 8 for the driving thereof, the electric motor being operated by a control unit 9. In the present case, the blower 6 is designed as a radial fan and the electric motor 8 is designed as a brushless DC motor. As a result, a compromise is reached between the required installation space, costs, and the performance of the seat ventilation device 5.

It is also possible, of course, that the blower 6 or the seat ventilation device 5 as a whole is situated only in the seat part 2 or in the seat part 2 and in the backrest 3. The seat ventilation device 5 can thus be installed directly in the foam of the vehicle seat 1 and can be adhered to a nonwoven fabric. The seat ventilation device 5 can also be suspended in the foam using rubber bands for acoustic decoupling. It is also conceivable to utilize an air distributor housing which is situated between the foam and the seat structure. In addition, the seat ventilation device 5, in particular, the blower 6, can be situated on the back side of a massage panel or lumbar panel. The seat ventilation device 5 can also be situated outside of the vehicle seat 1, on the vehicle seat, or on a body part of the motor vehicle comprising the vehicle seat 1.

By way of the seat ventilation device 5, the driving comfort should be increased for a person located on the seat 1 or also for other persons in the same motor vehicle. On the one hand, a person located on the vehicle seat 1 can be directly ventilated and air-conditioned by way of the seat ventilation device 5 and, on the other hand, the seat ventilation device 5 can also be utilized, in general, for air-conditioning the vehicle. In this case, it should be noted that neither the person located on the vehicle seat 1 nor other persons has/have their comfort unpleasantly limited by way of a noise development of the blower 6. During operation, the blower 6 conveys a volumetric flow through the air conduction ducts to the ventilation openings 7. If a person is located on the vehicle seat 1, the ventilation openings are completely or partially covered by the person, and therefore a counterpressure, which acts on the blower 6 in terms of air supply, increases and the volumetric flow is initially reduced. In the case of a 95% man, due to the greater weight thereof, the ventilation openings 7 are thus compressed due to a deformation of the backrest 3 by a greater extent than by a 5% woman. The seat ventilation device 5 must overcome the counterpressure to achieve the desired air-conditioning. A blower without rotational speed regulation delivers a greater volumetric flow in the presence of counterpresssure than does a seat ventilator having rotational speed regulation. The acoustics are impaired as a result, however, due to the increase in the rotational speed, which can reduce the driving comfort.

To overcome these drawbacks, it is provided to control the seat ventilation device 5 in a characteristic map-regulated manner, to reach an optimal compromise between the acoustics and the required volumetric flow.

To this end, FIG. 2 shows, in a simplified flow chart, a method for compiling a characteristic map KF which is used for operating the seat ventilation device 5.

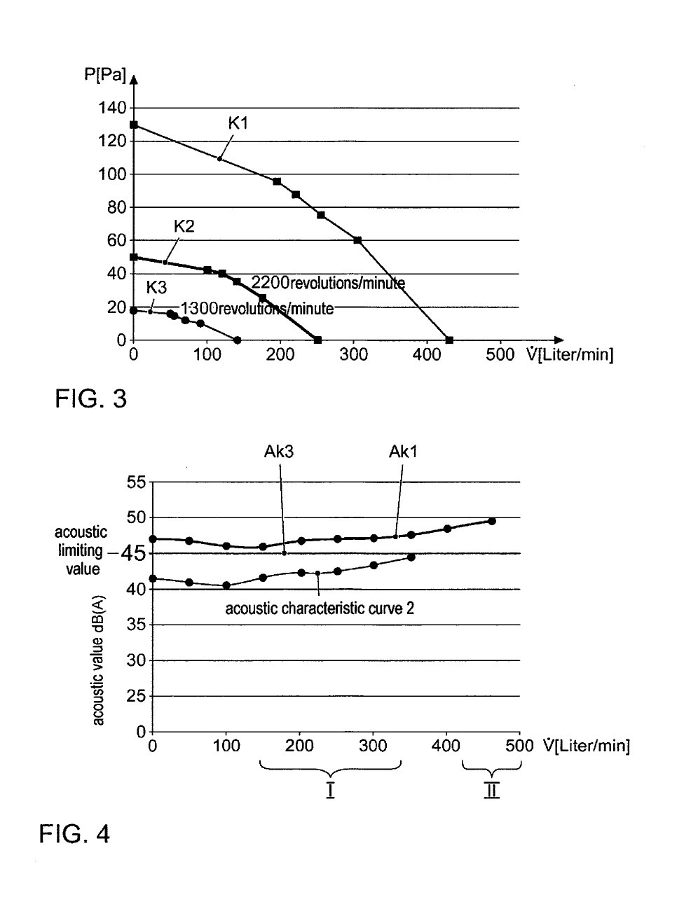

A present rotational speed of the brushless DC motor 8 can be registered in a sensor-free manner, by way of the registration of the countervoltage in the stator thereof. This value can be electronically evaluated and, therefore, the rotational speed can be held constant, independently of a counterpressure acting on the blower 6. This yields the curves K1, K2, K3 represented in FIG. 3 by way of example, each of which shows the ratio of counterpressure P to volumetric flow V at a constant rotational speed, wherein the rotational speed of the curve K1 is greater than that of the curve K2, and the rotational speed of the curve K2 is greater than that of the curve K3. The values represented in FIG. 3 are to be understood merely as examples.

The compilation of the characteristic map is started in a first operation at S1 of the method in FIG. 2. To this end, the electric motor 8 is controlled in an operation at S2 to set a setpoint rotational speed. In the present case, this takes place without a counterpressure acting on the blower 6, which acts in addition to the counterpressure generated by the air conduction ducts and the ventilation openings 7. Subsequently, in an operation at S3, an additional counterpressure is set or a counterpressure which is already present is increased. The operating current of the electric motor 8 changes as a result. The change in the counterpressure to a different counterpressure value is therefore reflected in a changed value of the operating current, which, in this regard, represents a present state value of the electric motor 8. This state value is stored in the characteristic map in an operation at S4 as a value characterizing the counterpressure. Simultaneously to, or temporally before or after the aforementioned, a present acoustic value of the blower 6 with respect to the set value of the counterpressure from operation at S3 is measured in a subsequent operation at S5. The registered acoustic value is compared, in a subsequent operation at S6, to a predefinable acoustic limiting value, which is 45 decibels (A) in the present case. If the result of the comparison is that the registered acoustic value exceeds (n) the acoustic limiting value, the setpoint rotational speed of the blower 6 or of the electric motor 8 is reduced in a subsequent operation at S7 and the present acoustic value is determined again. This adaptation of the rotational speed continues to take place until the determined acoustic value no longer exceeds the predefined acoustic limiting value and corresponds thereto (j). In this case, in a subsequent operation at S8, the adapted rotational speed, which has resulted in the permissible acoustic value, is stored in the same characteristic map as the value of the operating current and is assigned to the previously registered value of the operating current. The operating current and the adapted rotational speed are entered in a table.

FIG. 4 shows the characteristic curves AK1, AK2 and AK3 resulting from an acoustic measurement. The acoustic characteristic curve AK1 has been registered at a static rotational speed of 4300 revolutions per minute in the present case. It is apparent that the registered acoustic values of the characteristic curve AK1 are substantially higher than the predefinable acoustic limiting value of AWG=45 dB (A). The characteristic curve AK2, as a whole, is below the acoustic limiting value AWG. An unnecessary power loss therefore occurs. Characteristic curve AK3 has been generated by way of the above-described method, and therefore the rotational speed of the different counterpressures have been optimally adapted to the acoustic limiting value AWG, and therefore the maximum possible volumetric flow is always conveyed, independently of the counterpressure, by the blower 6 while complying with the acoustic condition.

To achieve the maximum volumetric flow V of the blower 6 in the presence of a changing counterpressure and while maintaining the permissible acoustics, the setpoint rotational speed is adapted during operation as a function of the counterpressure with the aid of the characteristic map KF.

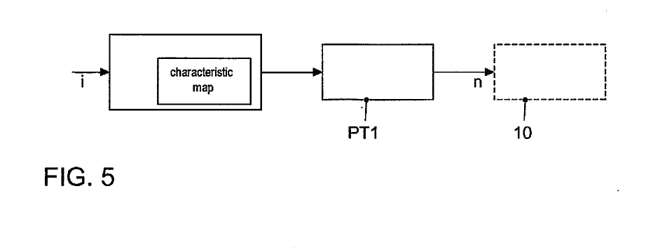

To this end, FIG. 5 shows, in a simplified representation, a function which is carried out by the control unit 9. During operation, the operating current is initially measured. This can take place by a suitable electronic circuit which, for example, is integrated into the control unit 9 or into the drive motor 8. With the aid of this state value, the control unit 9 cyclically determines, in regular time intervals t, the adapted rotational speed n from the characteristic map KF compiled by way of the above-described method, in particular, including a suitable interpolation. This adapted rotational speed n may be transmitted via a delay element PT1 to a motor controller 10 of the control unit 9 or of the drive motor 8. By way of a time constant T of the delay element, it can be determined how rapidly the rotational speed change is to take place.

By way of this proposed characteristic map regulation, a maximum volumetric flow from the blower 6 is always set, with consideration for the predefined acoustic limiting value, independently of a seat occupancy status or independently of a counterpressure acting on the blower 6, i.e., both in the case of an occupied seat according to region I in FIG. 4, and in the case of an unoccupied seat according to region II in FIG. 4.

1. A method for operating a seat ventilation device, the method comprising:
controlling at least one blower to set a setpoint rotational speed, wherein the at leas tone blower is provided in relationship to at least one ventilation opening situated in a seat surface; and
adapting the setpoint rotational speed as a function of a present state value of the at least one blower, which depends on a volumetric flow conveyed by the blower,
wherein the adapted rotational speed is selected from a characteristic map as a function of the present state value, wherein the characteristic map is/has been compiled as a function of a predefinable acoustic limiting value.

2. The method of claim 1, wherein, to compile the characteristic map, the blower is controlled to set the predefined setpoint rotational value and the conveyed volumetric flow is varied several times by changing a counterpressure acting on the blower, wherein, in each case, an acoustic value of the blower is measured and the rotational speed is adapted so that the measured acoustic value does not exceed a predefinable acoustic limiting value.

3. The method of claim 1, wherein, to compile the characteristic map, the rotational speed is adapted so that the registered acoustic values each correspond to the predefined acoustic limiting value.

4. The method of claim 1, wherein the counterpressure is continuously or incrementally increased to compile the characteristic map.

5. The method of claim 1, wherein, to compile the characteristic map, the state value of the blower is assigned to the presently measured acoustic value and is stored together with the acoustic value in the characteristic map.

6. The method of claim 1, wherein an operating current of an electric motor is determined or measured as the state value.

7. A device for operating a seat ventilation device, the device comprising:
at least one blower; and
at least one ventilation opening which is situated in a seat surface and has an air-ventilation connection to the blower, including a control unit for operating the blower,
wherein the control unit carries out a control method wherein the blower is controlled to set a setpoint rotational speed, and wherein the setpoint rotational speed is adapted as a function of a present state value of the blower, which depends on a volumetric flow conveyed by the blower,
wherein the adapted rotational speed is selected from a characteristic map as a function of the present state value, wherein the characteristic map is/has been compiled as a function of a predefinable acoustic limiting value.

8. A seat ventilation device comprising a device as claimed in claim 7.

9. The method of claim 6, wherein the electric motor is a brushless DC motor of the blower.

10. The device of claim 6, wherein, to compile the characteristic map, the blower is controlled to set the predefined setpoint rotational value and the conveyed volumetric flow is varied several times by changing a counterpressure acting on the blower, wherein, in each case, an acoustic value of the blower is measured and the rotational speed is adapted so that the measured acoustic value does not exceed a predefinable acoustic limiting value.

11. The device of claim 6, wherein, to compile the characteristic map, the rotational speed is adapted so that the registered acoustic values each correspond to the predefined acoustic limiting value.

12. The device of claim 6, wherein the counterpressure is continuously or incrementally increased to compile the characteristic map.

13. The device of claim 6, wherein, to compile the characteristic map, the state value of the blower is assigned to the presently measured acoustic value and is stored together with the acoustic value in the characteristic map.

14. The device of claim 6, wherein an operating current of an electric motor is determined or measured as the state value.
